(19) United States
(12) Patent Application Publication
(10) Pub. No.: US 2024/0227962 A1
(43) Pub. Date: Jul. 11, 2024

(54) BICYCLE CARRIER & ATTACHMENT MECHANISM

(71) Applicant: James Campbell, Peoria, AZ (US)

(72) Inventor: James Campbell, Peoria, AZ (US)

(21) Appl. No.: 18/095,021

(22) Filed: Jan. 10, 2023

(51) Int. Cl. B62J 9/23; B62J 7/04; B62K 15/00

(52) U.S. Cl. CPC B62J 9/23; B62J 7/04; B62K 15/006

(57) ABSTRACT

A bicycle carrier and attachment mechanism for folding bicycles utilizing either a rotating threaded connection mechanism or a sliding lock mechanism between the bicycle carrier and the back rack of a folding bicycle. The attachment mechanism enables a user to easily and releasably attach and detach the carrier to the back rack, such that the bicycle can be completely folded and more easily fit within storage containers or vehicular stowage areas.

### BACKGROUND OF THE INVENTION

### 1. Field of the Invention

This invention relates generally to bicycle carriers, and more specifically to bicycle carriers and attachment mechanisms.

### 2. Description of the Related Art

Prior art bicycle carriers are usually formed as baskets attached to the front handle bars or the rear fender or rack of a bicycle. The problem arises when the bicycle is a folding bicycle, wherein the basket prevents the bicycle from folding completely and as such becomes too bulky to fit within bicycle carriers, ie, a storage container or vehicular stowage areas. Thus, a need exists for a bicycle carrier having an attachment mechanism that is easily releasably attachable and detachable to the back rack of a folding bicycle to avoid the above-mentioned problems.

### BRIEF SUMMARY OF THE INVENTION

In view of the foregoing disadvantages inherent in the known types of bicycle carriers and attachment mechanisms or the like in the prior art, the present invention provides a novel bicycle carrier and attachment mechanism. As such, the general purpose of the present invention, which will be described subsequently in greater detail, is to provide a bicycle carrier and attachment mechanism utilizing either a rotating threaded connection mechanism or a sliding lock mechanism between the bicycle carrier and the back rack of a folding bicycle, such that the bicycle can be completely folded and more easily fit within storage containers or vehicular stowage areas, with all the advantages of the prior art and none of the disadvantages.

There has thus been outlined, rather broadly, the more important features of the invention in order that the detailed description thereof that follows may be better understood and in order that the present contribution to the art may be better appreciated. The features of the invention which are believed to be novel are particularly pointed out and distinctly claimed in the concluding portion of the specification. These and other features, aspects, and advantages of the present invention will become better understood with reference to the following drawings and

### BRIEF DESCRIPTION OF THE DRAWINGS

The figures which accompany the written portion of this specification illustrate embodiments and method(s) of use for the present invention, a bicycle carrier and attachment mechanism.

FIG. 1 shows a back perspective view of a folding bicycle including a bicycle carrier and rotating attachment mechanism according to an embodiment of the present invention.

FIG. 2 shows a bottom perspective view of the rotating attachment mechanism according to the embodiment of the present invention in FIG. 1.

FIG. 3 shows a top view of the back rack of a bicycle including support brackets for the rotating attachment mechanism according to the embodiment of the present invention in FIG.

1.

FIG. 4 shows a perspective view of the bucket portion of the carrier being attached to a bicycle via the rotating attachment mechanism according to the embodiment of the present invention in FIG. 1.

FIG. 5 shows a top perspective view of a second embodiment of the carrier formed as a wire basket having a sliding attachment mechanism, and the back rack of the bicycle including sliding brackets thereon.

FIG. 6 shows a top perspective view of the wire basket attached to the back rack of the bicycle via the sliding brackets according to the embodiment of FIG. 5.

FIG. 7 shows a top perspective view of a third embodiment wherein the wire basket is attached to the back rack of the bicycle via the rotating attachment mechanism.

FIG. 8 shows a top perspective view of a folding bicycle including the bottom portion of the rotating attachment mechanism folded into a storage container according to the embodiment of the present invention in FIG. 1.

The various embodiments of the present invention will hereinafter be described in conjunction with the appended drawings.

### DETAILED DESCRIPTION

As discussed above, embodiments of the present invention relate to a bicycle carrier and attachment mechanism for folding bicycles utilizing either a rotating threaded connection mechanism or a sliding lock mechanism between the bicycle carrier and the back rack of a folding bicycle. The attachment mechanism enables a user to easily and releasably attach and detach the carrier to the back fender rack, such that the bicycle can be completely folded and more easily fit within storage containers or vehicular stowage areas.

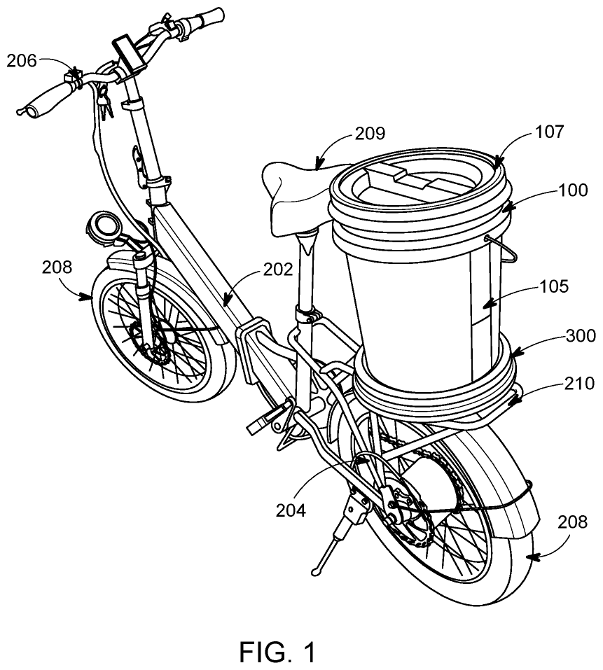

As shown in FIG. 1, the improved folding bicycle 200 of the instant invention includes a foldable frame 202 having a first frame portion 202, a second frame portion 204, wherein the second frame portion is pivotally connected to the first frame portion, such that the folding bicycle is adapted to fold between an in-use configuration and a storage configuration, handle bars 206 attached to the first frame portion, a seat 209 attached to the first frame portion, two wheels 208, wherein the first of the two wheels is rotatably attached to the first frame portion and the second of the two wheels is rotatably attached to the second frame portion, and a back rack 210 attached to the second frame portion and above the second of the two wheels.

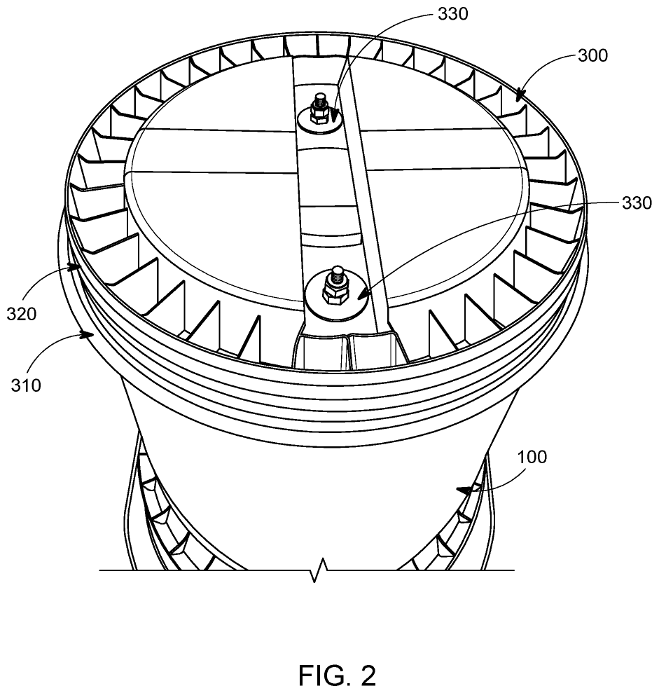

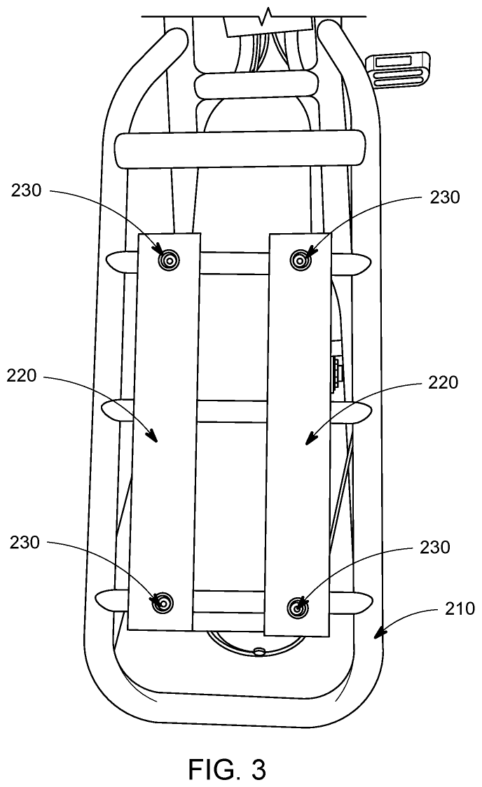

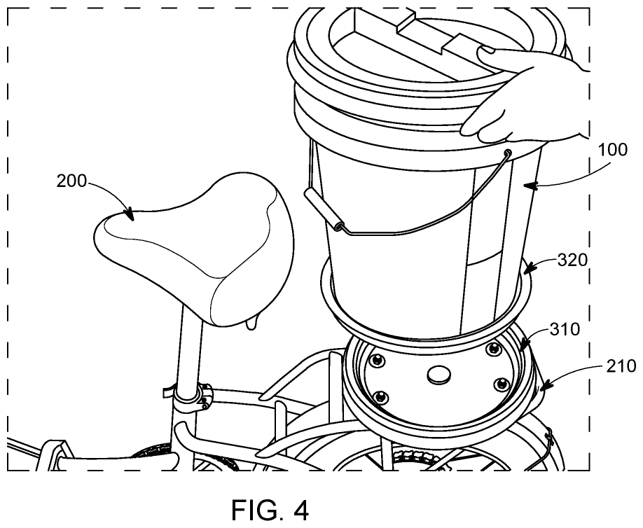

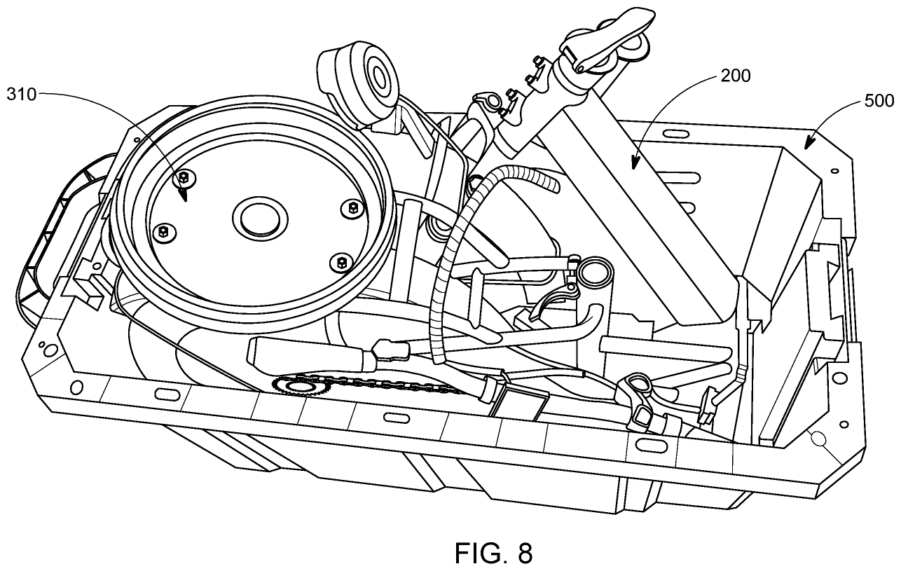

Referring now to the drawings FIGS. 1-4, the first embodiment of the bicycle carrier and attachment mechanism 100 for a folding bicycle 200 includes a carrier formed as a bucket 100 having a main body 105 and releasable top cover 107, and attachment mechanism 300 formed as a rotating threaded connection mechanism having a first portion 310 attached to the bottom of the bucket 100 and a second portion 320 adapted to be rotatably and releasably connected to the first portion 310. Second portion 320 further includes fasteners 330 adapted to releasably attach to fastener receivers 230 of brackets 220 that are adapted to be securely attached to the back rack 210 of the folding bicycle 200. In use, the folding bicycle 200 is unfolded into a riding configuration and the bucket 100 and first portion 310 of the attachment mechanism 300 is rotatably attached to the second portion 320 previously attached to the back rack 210. When a user is done riding folding bicycle 200 and using the bicycle carrier and attachment mechanism 100, the user unscrews the bucket 100 and first portion 310 from the second portion 320. The folding bicycle 200 is then folded and placed into it's appropriate storage apparatus, ie, storage container 500, as shown in FIG. 8.

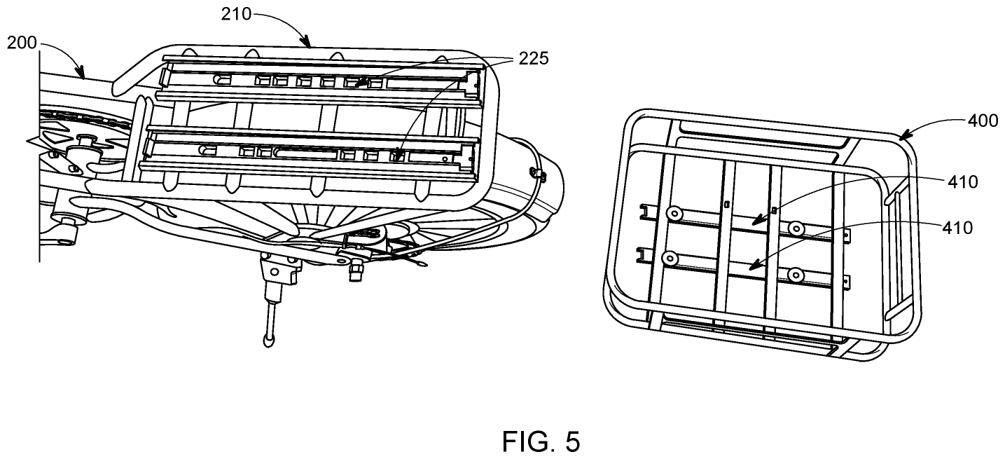

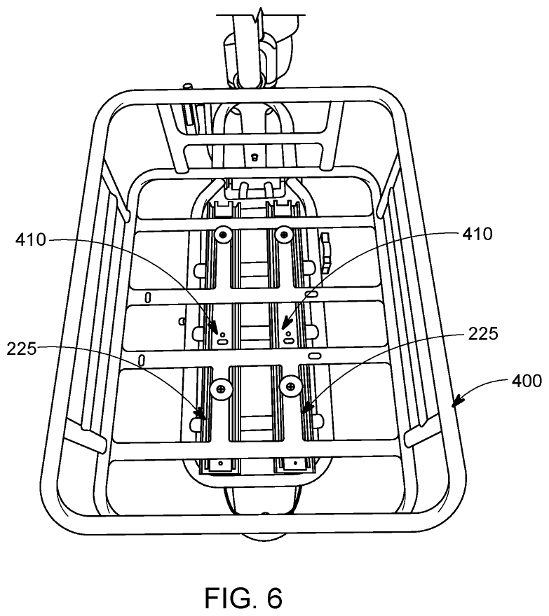

Referring now to the drawings FIGS. 5-7, a second embodiment of the bicycle carrier and attachment mechanism 100 for a folding bicycle 200 includes a wire basket 400 having a pair of slide brackets 410 attached thereto, and a sliding attachment mechanism including sliding rails 225 attached to the back rack of the folding bicycle 200. As such, the wire basket 400 is slid onto the sliding rails 225 into a secure position. And once the user is done, the wire basket 400 is slid off of the the sliding rails 225 and placed into storage.

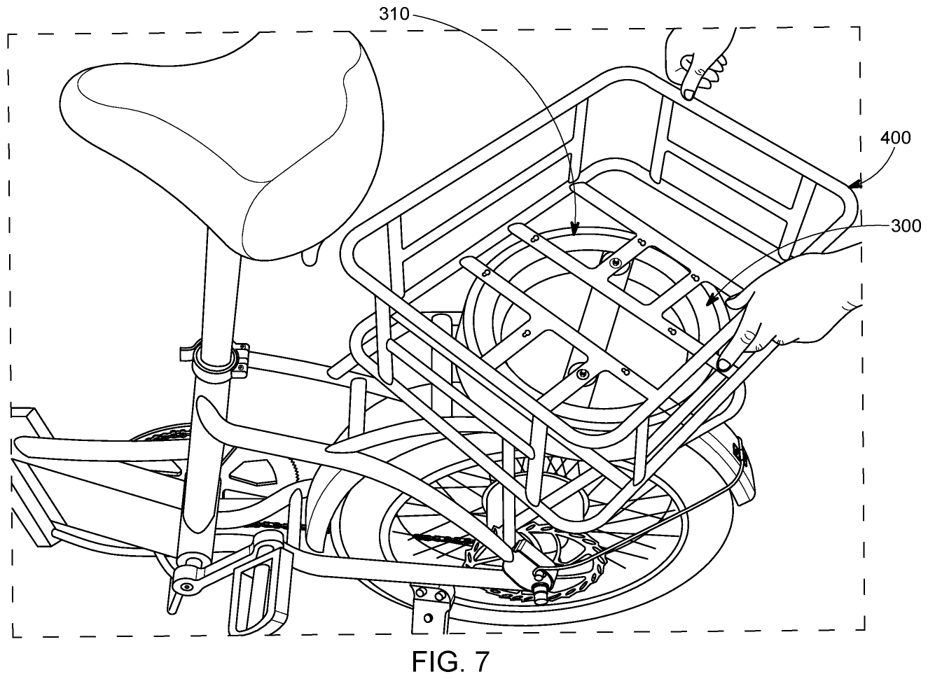

A third embodiment is shown in FIG. 7, wherein a hybrid of the first two embodiments results in the wire basket 400 being rotatably attached to the back bracket 210 of the folding bicycle 200 via attachment mechanism 300.

A safety lock pin may also be incorporated to lock the bucket from turning when riding the bicycle. The safety pin prevents the rotation of the first portion 310 of the attachment mechanism 300 with respect to the second portion 320 thereof. The safety lock pin can be formed as a ¼″ bolt with a nut, or as a ¼″ quick release pin, or as a ¼″ lockable hitch pin.

The bucket 100 may be formed as a 5 gallon plastic bucket, however, it can be formed in other sizes and from other materials, such as aluminum. The attachment mechanism 100 can also be formed from other materials, including plastic and aluminum. The folding bicycle 200 may be formed as a folding electric bicycle or any other known type of folding bicycles or electric or smart bicycles.

The first portion 310 and second portion 320 of the attachment mechanism 300 may be formed from a molding process, and further may be formed with or without interdigitating threads depending on the type of attachment mechanism 300 needed or the type of attachment mechanism in use. Furthermore, the attachment mechanism 300 is adapted to be used with any shape bicycle carrier, ie, circular, square, or rectangular.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and

Trademark Office and the public generally, and especially the scientist, engineers and practitioners in the art who are not familiar with patent or legal terms or phraseology, to determine quickly from a cursory inspection the nature and essence of the technical disclosure of the application.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

What is claimed is:

1. A bicycle carrier and attachment mechanism comprising:
bicycle carrier including:
a main body including:
at least one side wall having a top rim portion; and
a bottom wall attached to a lower portion of said at least one side wall;
wherein said bottom wall and said at least one side wall form an interior volume; and
wherein said bicycle carrier is adapted to releasably retain materials therein; and an attachment mechanism including;
a first portion;
wherein said first portion is attached to an underside portion of said bottom wall of said main body of said bicycle carrier; and
a second portion;
wherein said second portion is adapted to be attached to a back rack of a folding bicycle;
wherein said second portion is adapted to be releasably connected to said first portion, and as such said bicycle carrier is adapted to be releasably connected to said back rack of said folding bicycle.

2. The bicycle carrier and attachment mechanism of claim 1, wherein said first portion of said attachment mechanism is adapted to be releasably and rotatably connected to said second portion via interdigitating threads.

3. The bicycle carrier and attachment mechanism of claim 1, wherein said first portion of said attachment mechanism is adapted to be releasably and slidably connected to said second portion via interconnecting slide brackets and slide rails.

4. The bicycle carrier and attachment mechanism of claim 1, wherein said bicycle carrier is formed as a cylindrical bucket; wherein said at least one side wall of said main body includes a top rim portion; and wherein said bicycle carrier further includes a releasable top cover adapted to releasably connect with said top rim portion of said side wall of said main body.

5. The bicycle carrier and attachment mechanism of claim 1, wherein said bicycle carrier is formed as a wire basket.

6. An improved folding bicycle comprising:
a foldable frame including:
a first frame portion;
a second frame portion;
wherein said second frame portion is pivotally connected to said first frame portion, such that said folding bicycle is adapted to fold between an in-use configuration and a storage configuration;
handle bars;
wherein said handle bars are attached to said first frame portion;
a seat;
wherein said seat is attached to said first frame portion;
two wheels;
wherein a first of said two wheels is rotatably attached to said first frame portion;
and wherein a second of said two wheels is rotatably attached to said second frame portion;
a back rack;
wherein said back rack is attached to said second frame portion and above said second of said two wheels; and
a bicycle carrier and attachment mechanism comprising:
a bicycle carrier including:
a main body including:
at least one side wall having a top rim portion; and
a bottom wall attached to a lower portion of said at least one side wall;
wherein said bottom wall and said at least one side wall form an interior volume; and
wherein said bicycle carrier is adapted to releasably retain materials therein; and
an attachment mechanism including;
a first portion;
wherein said first portion is attached to an underside portion of said bottom wall of said main body of said bicycle carrier; and
a second portion;
wherein said second portion is adapted to be attached to said back rack of said folding bicycle;
wherein said second portion is adapted to be releasably connected to said first portion, and as such said bicycle carrier is adapted to be releasably connected to said back rack of said folding bicycle.

7. The improved folding bicycle of claim 6, wherein said first portion of said attachment mechanism is adapted to be releasably and rotatably connected to said second portion via interdigitating threads.

8. The improved folding bicycle of claim 6, wherein said first portion of said attachment mechanism is adapted to be releasably and slidably connected to said second portion via interconnecting slide brackets and slide rails.

9. The improved folding bicycle of claim 6, wherein said bicycle carrier is formed as a cylindrical bucket; wherein said at least one side wall of said main body includes a top rim portion; and wherein said bicycle carrier further includes a releasable top cover adapted to releasably connect with said top rim portion of said side wall of said main body.

10. The improved folding bicycle of claim 6, wherein said bicycle carrier is formed as a wire basket.
